(19) United States
(12) Patent Application Publication
(10) Pub. No.: US 2026/0236726 A1
(43) Pub. Date: Aug. 13, 2026

(54) INFORMATION PROCESSING APPARATUS, METHOD, AND NON-TRANSITORY COMPUTER-READABLE STORAGE MEDIUM STORING COMPUTER PROGRAM OF CORRECTING PROFILE FOR CONVERTING COLOR VALUE INTO INK AMOUNT

(71) Applicant: SEIKO EPSON CORPORATION, TOKYO (JP)

(72) Inventors: Shota ITAGAKI, SHIOJIRI-SHI (JP); Takahiro KAMADA, MATSUMOTO-SHI (JP); Mitsuhiro YAMASHITA, MATSUMOTO-SHI (JP); Takuya ONO, SHIOJIRI-SHI (JP); Yuko YAMAMOTO, SHIOJIRI-SHI (JP)

(21) Appl. No.: 19/460,410

(22) Filed: Jan. 27, 2026

(30) Foreign Application Priority Data
Jan. 27, 2025 (JP) 2025-011219

(51) Int. Cl. G06K 15/00; G06K 15/02

(52) U.S. Cl. CPC G06K 15/407; G06K 15/1878; G06K 2215/0094; G06K 2215/101

(57) ABSTRACT

An information processing apparatus includes an optimization condition setting unit configured to set an optimization condition including an image quality index value related to an ink amount, a grid point selection unit configured to select a target grid point to be corrected out of a plurality of grid points contained in a profile for converting a color value into the ink amount, an ink amount correction unit configured to correct the ink amount at the target grid point into a corrected ink amount by executing optimization processing so as to improve the image quality index value, and a profile correction unit configured to correct the profile using the corrected ink amount.

The present application is based on, and claims priority from JP Application Serial Number 2025-011219, filed Jan. 27, 2025, the disclosure of which is hereby incorporated by reference herein in its entirety.

### BACKGROUND

### 1. Technical Field

The present disclosure relates to an information processing apparatus, a method, and a non-transitory computer-readable storage medium storing a computer program of correcting a profile for converting a color value into an ink amount.

### 2. Related Art

When color printing is performed with a printing apparatus, an ICC profile for converting a color value into an ink amount is used. As the color value, a value in a device-independent color space such as CIE-L*a*b* color space or CIE-XYZ color space is used. In the present disclosure, the ICC profile is also simply referred to as a “profile”.

Since a plurality of color inks is used for color printing, there are many combinations of ink amounts representing the same color value. Therefore, as the ink amount registered in the profile, it is desirable to adopt an ink amount good in image quality index value such as graininess.

JP-A-2013-21517 discloses a method of determining a division condition for performing color conversion of an input color signal into a device color signal. In this related art, in order to optimize an image for each local region, a degree of influence of graininess on a pixel of interest is estimated based on an amount of ink used in the pixel of interest and surrounding pixels, and the amount of the ink used in the pixel of interest is determined so that the graininess is improved.

JP-A-2013-21517 is an example of the related art.

However, in the related art described above, it is necessary to execute processing for improving image quality every time the image changes. Therefore, a technique capable of improving the image quality independently of the image is desired.

### SUMMARY

According to a first aspect of the present disclosure, there is provided an information processing apparatus that corrects a profile for converting a color value into an ink amount. The information processing apparatus includes an optimization condition setting unit configured to set an optimization condition including an image quality index value related to the ink amount, a grid point selection unit configured to select a target grid point to be corrected out of a plurality of grid points contained in the profile, an ink amount correction unit configured to correct the ink amount at the target grid point into a corrected ink amount by executing optimization processing so as to improve the image quality index value, and a profile correction unit configured to correct the profile using the corrected ink amount.

According to a second aspect of the present disclosure, there is provided a method of correcting a profile for converting a color value into an ink amount. The method includes (a) setting an optimization condition including an image quality index value related to the ink amount, (b) selecting a target grid point to be corrected out of a plurality of grid points contained in the profile, (c) correcting the ink amount at the target grid point into a corrected ink amount by executing optimization processing so as to improve the image quality index value, and (d) correcting the profile using the corrected ink amount.

According to a third aspect of the present disclosure, there is provided a non-transitory computer-readable storage medium storing a computer program for correcting a profile for converting a color value into an ink amount. The computer program makes a computer execute processing including (a) setting an optimization condition including an image quality index value related to the ink amount, (b) selecting a target grid point to be corrected out of a plurality of grid points contained in the profile, (c) correcting the ink amount at the target grid point into a corrected ink amount by executing optimization processing so as to improve the image quality index value, and (d) correcting the profile using the corrected ink amount.

### BRIEF DESCRIPTION OF THE DRAWINGS

FIG. 1 is a diagram illustrating a configuration of a printing system.

FIG. 2 is a diagram illustrating a function of an information processing apparatus.

FIG. 3 is a flowchart showing a procedure of profile correction processing in a first embodiment.

FIG. 4 is a diagram illustrating an example of a window used for setting an optimization condition.

FIG. 5 is a diagram illustrating an example of a window used for selecting a target grid point.

FIG. 6 is a diagram illustrating another example of the window used for selecting the target grid point.

FIG. 7 is a diagram illustrating an example of a relationship between an input color value and the target grid points.

FIG. 8 is a flowchart showing a processing procedure in step S30 in the first embodiment.

FIG. 9 is a diagram illustrating an example of a window used for adjusting image quality index values and objective functions.

FIG. 10 is a flowchart showing a processing procedure in step S30 in a second embodiment.

FIG. 11 is a diagram illustrating an example of an allowable range related to an ink amount at the target grid point.

FIG. 12 is a flowchart showing a procedure of profile correction processing in a third embodiment.

FIG. 13 is a diagram illustrating an example of a window used for setting a smoothing range.

FIG. 14 is a diagram illustrating an example of a smoothing range of the ink amount.

FIG. 15 is a flowchart showing a processing procedure in step S30 in the third embodiment.

FIG. 16 is a diagram illustrating an example of allowable ranges related to the ink amounts at surrounding grid points.

### DESCRIPTION OF EMBODIMENTS

### A. First Embodiment

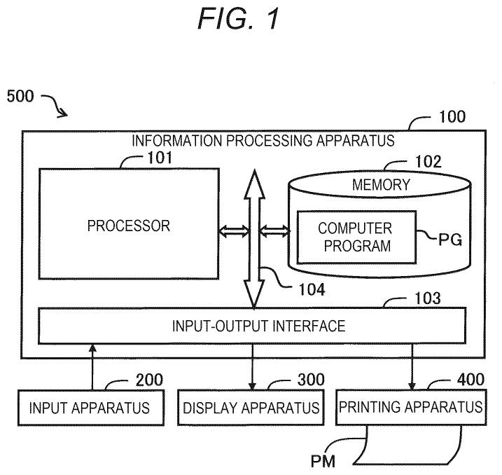

FIG. 1 is a diagram illustrating a configuration of a printing system 500 according to a first embodiment. The printing system 500 includes an information processing apparatus 100, an input apparatus 200, a display apparatus 300, and a printing apparatus 400. However, the printing apparatus 400 can be omitted.

The information processing apparatus 100 includes a processor 101, a memory 102, an input-output interface 103, and an internal bus 104. The processor 101, the memory 102, and the input-output interface 103 are connected via the internal bus 104 so as to be able to communicate bi-directionally with each other. The memory 102 includes a volatile memory including a main memory and a video memory, and a nonvolatile memory such as a hard disk or a solid state drive (SSD). The input apparatus 200, the display apparatus 300, and the printing apparatus 400 are connected to the input-output interface 103 of the information processing apparatus 100 with wired communication or wireless communication. The input apparatus 200 is, for example, a keyboard or a mouse, and the display apparatus 300 is, for example, a liquid crystal display. The input apparatus 200 and the display apparatus 300 may be integrated as a touch panel. The printing apparatus 400 is, for example, an inkjet printer, and prints an image on a print medium PM using a plurality of types of ink.

As described below, the information processing apparatus 100 executes processing of correcting a profile for converting a color value into an ink amount. The profile to be corrected is an ICC profile for the printing apparatus 400. In the present disclosure, an “ink amount” registered in the profile means a combination of amounts of the ink used related to the plurality of types of ink. For example, when the printing apparatus 400 can use six types of ink, the “ink amount” is a combination of the amounts of the six types of ink used. In order to clarify this meaning, the “ink amount” can also be referred to as a “set of ink amounts”. In addition, the amount of the ink used related to one type of ink can be referred to as an “individual ink amount”.

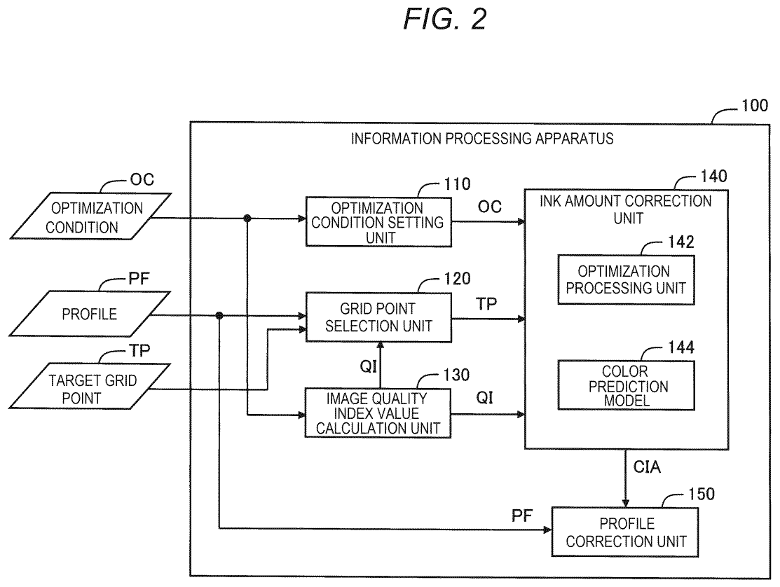

FIG. 2 is a diagram illustrating an example of a configuration of the information processing apparatus 100. The information processing apparatus 100 includes an optimization condition setting unit 110, a grid point selection unit 120, an image quality index value calculation unit 130, an ink amount correction unit 140, and a profile correction unit 150. The ink amount correction unit 140 includes an optimization processing unit 142 that executes optimization processing for an image quality improvement, and a color prediction model 144 that converts the ink amount into a color value. Functions of these units are implemented by software by the processor 101 executing a computer program PG stored in advance in the memory 102. However, some of the functions of the units may be implemented by hardware circuits.

The optimization condition setting unit 110 sets an optimization condition OC including an image quality index value QI related to the ink amount. The grid point selection unit 120 selects a target grid point TP as a target of correction of the ink amount out of the plurality of grid points contained in a profile PF. The image quality index value calculation unit 130 calculates the image quality index value QI related to the ink amount at the target grid point TP. The ink amount correction unit 140 corrects the ink amount at the target grid point TP into a corrected ink amount CIA by executing the optimization processing so as to improve the image quality index value QI. The profile correction unit 150 corrects the profile PF using the corrected ink amount CIA.

The color prediction model 144 has a function of converting the ink amount into the color value. As the color prediction model 144, for example, it is possible to use a model in which the ink amount is converted into a spectral reflectance using a spectral printing model converter described in JP-T-2007-511175, and then a color matching function is applied to the spectral reflectance to calculate the color value.

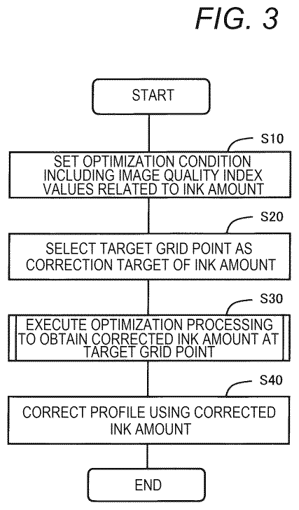

FIG. 3 is a flowchart showing a procedure of profile correction processing in the first embodiment. In step S10, the optimization condition setting unit 110 sets the optimization condition OC including the image quality index value QI related to the ink amount.

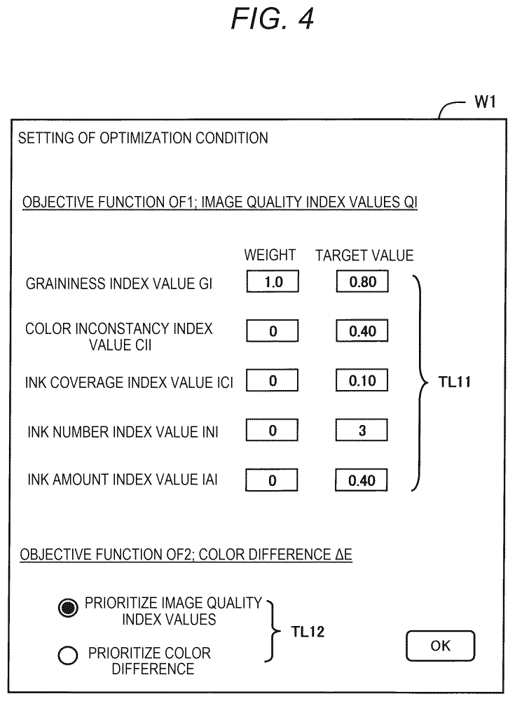

FIG. 4 is a diagram illustrating an example of a window used for setting the optimization condition. This window W1 includes a tool TL11 for setting a first objective function OF1 and a tool TL12 for setting a second objective function OF2. The window W1 is a kind of graphical user interface (GUI) that receives a designation by a user. The same applies to other windows described later.

The first objective function OF1 is an objective function including the image quality index value QI. In the example in FIG. 4, it is possible to set the first objective function OF1 so as to include one or more of a graininess index value GI, a color inconstancy index value CII, an ink coverage index value ICI, an ink number index value INI, and an ink amount index value IAI.

The graininess index value GI is an index value representing graininess of an image. As the graininess index value GI, for example, a graininess index number described in JP-A-2007-281723 can be used. The smaller the graininess index value GI is, the more preferable.

The color inconstancy index value CII is an index value representing a color difference when one object color is observed under a different observation condition. As the color inconstancy index value CII, for example, a color inconstancy index (CII) described in JP-T-2007-511175 can be used. The smaller the color inconstancy index value CII is, the more preferable.

The ink coverage index value ICI is an index value related to an area ratio of a region covered with the ink. The ink coverage can be calculated by, for example, a Murray-Davies model described in JP-A-2007-281723. When a plurality of types of ink is ejected to the same pixel, the ink coverage can be calculated in accordance with the total ejection amount of those types of ink. The ink coverage index value ICI is the ink coverage itself calculated from the corrected ink amount CIA at the target grid point TP. The smaller the ink coverage index value ICI is, the more preferable.

The ink number index value INI is an index value related to an ink number constituting the ink amount. The “ink number” is the number of types of ink the individual ink amounts of which are not zero. Since color turbidity increases as the ink number increases, the ink number can be considered as an index value representing the color turbidity. The ink number index value INI is, for example, the ink number in the corrected ink amount CIA at the target grid point TP. The smaller the ink number index value INI is, the more preferable.

The ink amount index value IAI is an index value related to a total value of the individual ink amounts of the respective types of ink. The ink amount index value IAI is, for example, the total value of the individual ink amounts constituting the corrected ink amount CIA at the target grid point TP. The smaller the ink amount index value IAI is, the more preferable.

The first objective function OF1 is given as, for example, the following expression.

OF1=K1×ΔGI+K2×ΔCII+K3×ΔICI+K4×ΔINI+K5×ΔIAI (q1),
where
ΔGI is a difference between a target value of the graininess index value and the graininess index value related to the corrected ink amount,
ΔCII is a difference between a target value of the color inconstancy index value and the color inconstancy index value related to the corrected ink amount,
ΔICI is a difference between a target value of the ink coverage index value and the ink coverage index value related to the corrected ink amount,
ΔINI is a difference between a target value of the ink number index value and the ink number index value related to the corrected ink amount,
ΔIAI is a difference between a target value of the ink amount index value and the ink amount index value related to the corrected ink amount,
K1 to K5 are each a coefficient no smaller than 0, and at least one of K1 to K5 is nonzero.

The first tool TL11 includes input fields for setting the weight coefficients K1 to K5 and the target values for the respective image quality index values QI.

The following expression may be used instead of the above expression (q1).

OF1=K1×GI_c+K2×CII_c+K3×ICI_c+K4×INI_c+K5×IAI_c (q2),
where
GI_c is the graininess index value related to the corrected ink amount,
CII_c is the color inconstancy index value related to the corrected ink amount,
ICI_c is the ink coverage index value related to the corrected ink amount,

INI_c is the ink number index value related to the corrected ink amount, and
IAI_c is the ink amount index value related to the corrected ink amount.

In the example in FIG. 4, the weight coefficient of the graininess index value GI is set to 1.0, and the weight coefficients of the other image quality index values are set to 0. Note that the first tool TL11 may be configured so as to be able to select only one of the plurality of image quality index values.

The second objective function OF2 relates to a color difference ΔE. The “color difference ΔE” is a color difference between an original color value (Lab value) at the target grid point TP and a color value reproduced by the corrected ink amount CIA. The color difference ΔE is calculated by, for example, the following procedure.
(a1) The ink amount correction unit 140 executes optimization using the objective functions OF1, OF2 to correct the ink amount at the target grid point TP into the corrected ink amount CIA.
(a2) The ink amount correction unit converts the corrected ink amount CIA into a color value using the color prediction model 144.
(a3) The color difference ΔE between the color value after the conversion and the original color value at the target grid point TP is calculated.

It is preferable that the color value reproduced by the corrected ink amount CIA substantially coincides with the original color value. That is, the target value of the color difference ΔE is preferably a minute value close to zero. The target value of the color difference ΔE is also referred to as an “allowable color difference”. In the example in FIG. 4, a field in which the target value of the color difference ΔE is input is not provided, and a target value set in advance is used. Alternatively, the user may input the target value of the color difference ΔE.

In the tool TL12 for the second objective function OF2, it is specified that the first objective function OF1 related to the image quality index values QI is prioritized over the second objective function OF2 related to the color difference ΔE. The term “prioritize” means which of the first objective function OF1 and the second objective function OF2 is prioritized in correcting the ink amount when the corrected ink amount CIA which satisfies the target values of the first objective function OF1 fails to be found in the optimization processing.

The weights in a weighting method in multi-objective optimization may be set in accordance with options of “priority”. For example, when it is specified that the first objective function OF1 is prioritized over the second objective function OF2, the weight of the first objective function OF1 is set to a value larger than the weight of the second objective function OF2. The “weighting method in multi-objective optimization” is a method of creating one evaluation function by weighting a plurality of objective functions and finding an optimum solution as single-objective optimization.

In the weighting method in multi-objective optimization, an evaluation function EF given by the following expression is used.

EF=C1×OF1+C2×OF2 (q3)

Here, C1 and C2 are weight coefficients no smaller than 0, and at least one of C1 and C2 is nonzero. As the weight coefficients C1, C2 of the objective functions OF1, OF2, values set in advance are used in accordance with the setting of the tool TL12. Alternatively, the user may set the weight coefficients C1, C2 of the objective functions OF1, OF2.

Instead of the weighting method, Pareto optimization may be executed. When the Pareto optimization is executed, one solution in which a value of the objective function OF to be prioritized is the best is selected from a plurality of Pareto optimal solutions. When the Pareto optimization is used, the Pareto optimization may be performed using a plurality of image quality index values as separate objective functions. In this case, the user may designate priorities of the plurality of image quality index values as the optimization condition.

In step S20 in FIG. 3, the grid point selection unit 120 selects one or more target grid points TP as the targets of correction of the ink amount from the plurality of grid points of the profile PF.

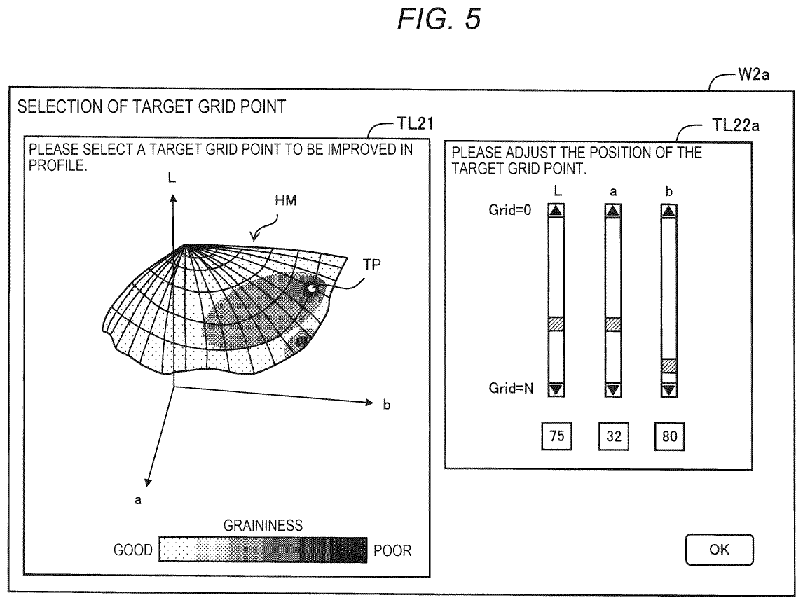

FIG. 5 is a diagram illustrating an example of a window used for selecting the target grid point TP. This window W2a includes a tool TL21 for the user to designate the position of the target grid point TP in a color value space, and a tool TL22a for the user to adjust the position of the target grid point TP. In the present embodiment, the color value space is the Lab space.

In the tool TL21, a gamut configured with a plurality of grid points contained in the profile PF is drawn as a heat map HM corresponding to the image quality index value of each grid point. The grid points of the gamut coincide with the grid points of the profile PF. In the example in FIG. 5, the graininess index value GI selected by the first objective function OF1 in FIG. 4 is used as the image quality index value. The user can designate, as the target grid point TP, a grid point at which the image quality index value needs to be improved with reference to the heat map HM. The target grid point TP thus designated is highlighted so as to be identifiable from other grid points. Note that the value of the first objective function OF1 may be displayed instead of the image quality index value.

In the tool TL22a for adjustment, the color value at the target grid point TP thus designated is indicated by slide bars. The user can adjust the position of the target grid point TP by adjusting the color value at the target grid point TP using the slide bars. It is preferable that when the color value at the target grid point TP is adjusted using the tool TL22a for adjustment, the position of the target grid point TP in the heat map HM also changes accordingly.

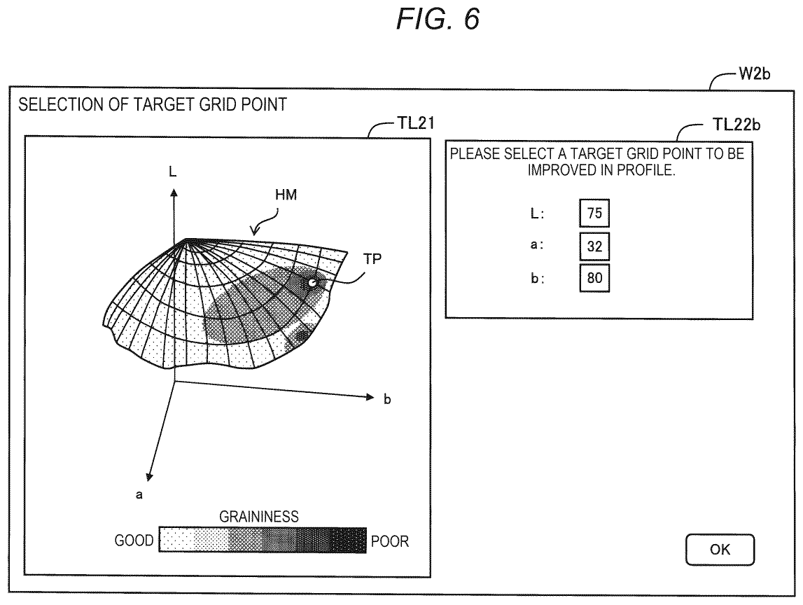

FIG. 6 is a diagram illustrating another example of the window used for selecting the target grid point TP. In this window W2b, a tool TL22b for directly inputting the color value at the target grid point TP is provided instead of the tool TL22a for adjustment illustrated in FIG. 5. The user can set the position of the target grid point TP by designating the color value using the tool TL22b. When the color value at the target grid point TP is designated using the tool TL22b, the position of the target grid point TP in the heat map HM is highlighted accordingly.

An input color value set using the tool TL22a for adjustment illustrated in FIG. 5 or the tool TL22b for input illustrated in FIG. 6 may not correspond to any of the plurality of grid points contained in the profile PF in some cases. In this case, as described below, it is preferable that a plurality of grid points located near the position represented by the input color value in the color value space is automatically selected as the target grid points TP.

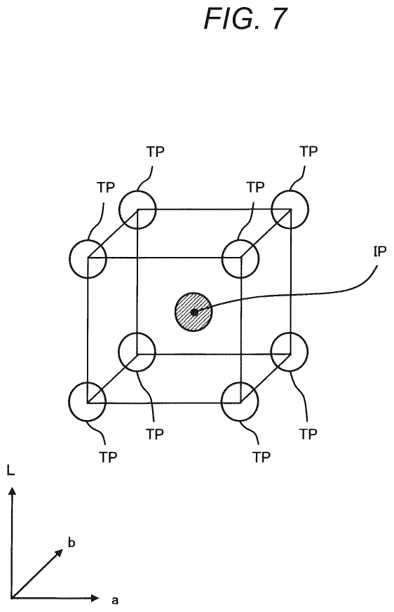

FIG. 7 is a diagram illustrating an example of a relationship between the input color value and the target grid points TP. In this example, an input point IP represented by the input color value is located at a position shifted from the grid points of the profile PF. In this case, the grid point selection unit 120 automatically selects eight grid points the closest to the input point IP as the target grid points TP. Note that when the input point IP is located on a grid plane, it is preferable to automatically select four grid points closest to the input point IP as the target grid points TP. Further, when the input point IP is located on a grid line, it is preferable to automatically select two grid points closest to the input point IP as the target grid points TP.

Note that the grid point selection unit 120 may be configured so as to automatically select a grid point at which the image quality index value QI or the objective function OF1 does not reach the target value, that is, a grid point worse than the target value, as the target grid point TP, instead of selecting the target grid point TP in accordance with the designation by the user.

In step S30 in FIG. 3, the ink amount correction unit 140 executes the optimization processing to obtain the corrected ink amount CIA at the target grid point TP.

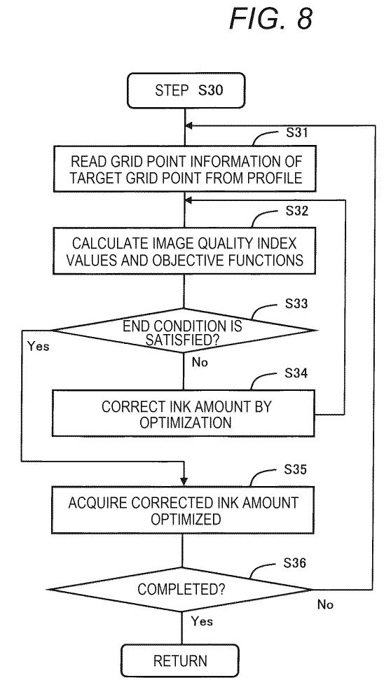

FIG. 8 is a flowchart showing a processing procedure of step S30. In step S31, the ink amount correction unit 140 reads grid point information of the target grid point TP from the profile PF. The grid point information includes an index of the grid point, the color value at the grid point, and the ink amount at the grid point. The index of the grid point is a number for identifying the grid point.

In step S32, the optimization processing unit 142 calculates the image quality index values QI and the objective functions OF1, OF2 related to the target grid point TP. The image quality index values QI are calculated by the image quality index value calculation unit 130, and the optimization processing unit 142 is notified of the image quality index values QI thus calculated. When the weighting method in multi-objective optimization is used, the evaluation function EF is calculated in accordance with the expression (q3) described above. In step S32, the user may adjust the image quality index values QI and the objective functions OF1, OF2.

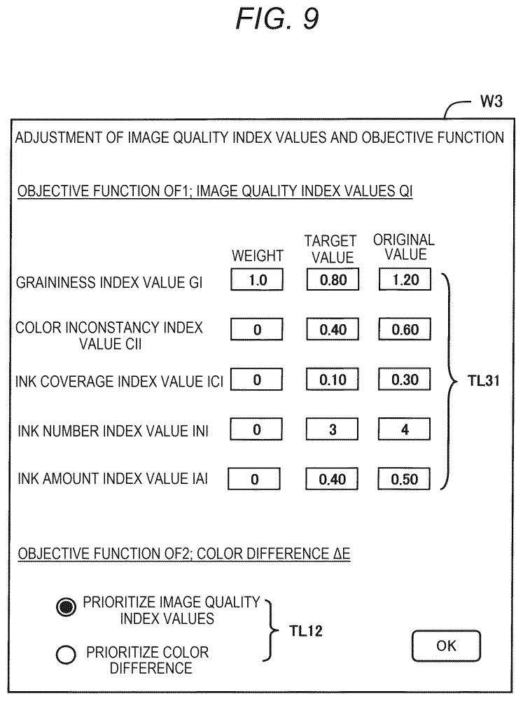

FIG. 9 is a diagram illustrating an example of a window used for adjusting the image quality index values QI and the objective functions OF1, OF2. This window W3 is obtained by changing the tool TL11 for setting in the window W1 for setting the optimization condition shown in FIG. 4 to a tool TL31 for adjustment. In the tool TL31 for adjustment, an original value is displayed in addition to the weight coefficient and the target value for each of the image quality index values. The “original value” is an image quality index value calculated from the ink amount before the correction at the target grid point TP. The user can adjust the weight coefficient and the target value with reference to the original value. In addition, it is possible to reset which of the image quality index value and the color difference is prioritized using the tool TL12 for the second objective function OF2.

In step S33 in FIG. 8, the ink amount correction unit 140 determines whether an end condition of the optimization is satisfied. For example, the end condition of the optimization is satisfied when one of a first condition that “one of the objective functions OF1, OF2 or the evaluation function EF becomes equal to or less than a target value set in advance” and a second condition that “the number of times of the execution of the optimization processing reaches an upper limit number of times set in advance” is satisfied. When the end condition of the optimization is not satisfied, the process proceeds to step S34, the optimization processing unit 142 corrects the ink amount in accordance with the optimization algorithm, and then the process returns to step S32.

On the other hand, when the end condition of the optimization is satisfied, the process proceeds to step S35, and the ink amount correction unit 140 acquires the corrected ink amount CIA thus optimized. The profile correction unit 150 is notified of the corrected ink amount CIA.

In step S36, the ink amount correction unit 140 determines whether the processing for all the target grid points TP is completed. When the processing is not completed, the process returns to step S31, and the processing in steps S31 to S36 is executed for the next target grid point TP. When the processing is completed, the processing in FIG. 8 ends.

In step S40 in FIG. 3, the profile correction unit 150 corrects the profile PF using the corrected ink amount CIA. Specifically, in the grid point information of the target grid point TP contained in the B2A table of the profile PF, the original ink amount is replaced with the corrected ink amount CIA. In this way, the profile PF with the image quality index values improved can be obtained.

As described above, in the first embodiment, since the profile PF is corrected so as to improve the image quality index values QI, the image quality can be improved independently of the image.

### B. Second Embodiment

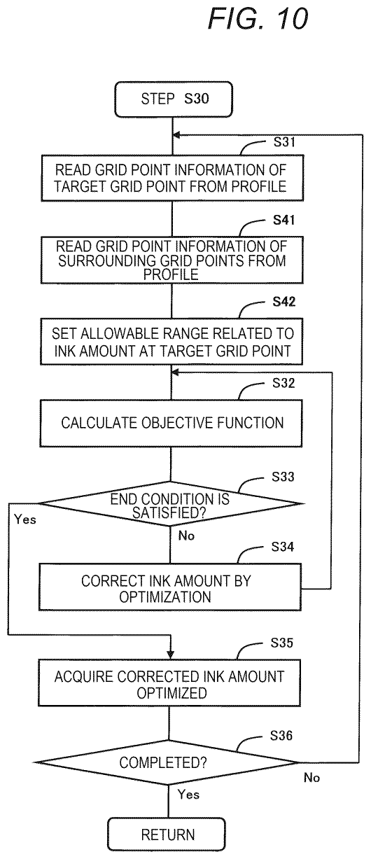

FIG. 10 is a flowchart showing a processing procedure of step S30 in a second embodiment. An apparatus configuration in the second embodiment and an overall procedure of the processing shown in FIG. 3 are the same as those in the first embodiment. The second embodiment is different from the first embodiment in the point that steps S41, S42 are inserted between step S31 and step S32 in the detailed procedure of step S30, and is substantially the same as the first embodiment in other points.

In step S41, the ink amount correction unit 140 reads the grid point information of surrounding grid points existing around the target grid point TP from the profile PF. In step S42, the ink amount correction unit 140 sets the allowable range related to the ink amount at the target grid point.

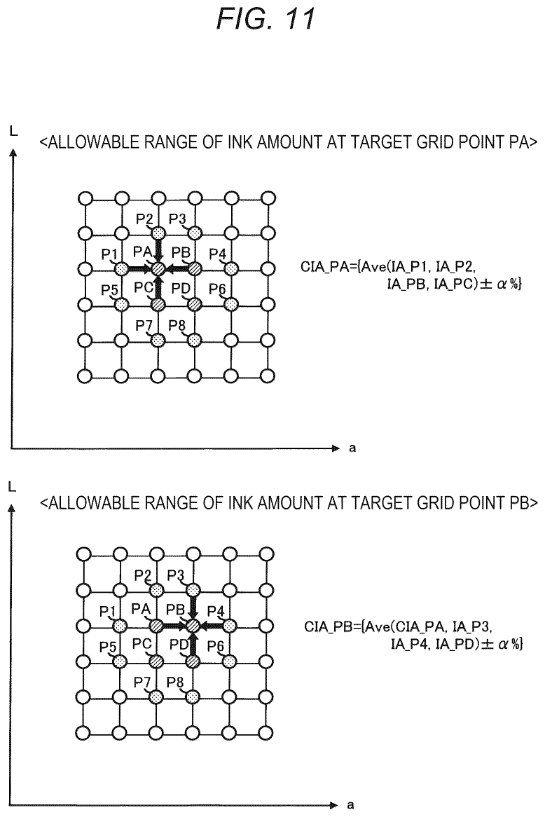

FIG. 11 is a diagram illustrating an example of the allowable range related to the ink amount at the target grid point. Here, four target grid points PA, PB, PC, and PD and surrounding grid points P1 to P8 existing around the target grid points PA, PB, PC, and PD are hatched. Regarding four target grid points PA, PB, PC, and PD, it is assumed that the corrected ink amounts CIA are determined in this order. The surrounding grid points P1 to P8 used to determine the allowable range are determined in accordance with a rule set in advance. Alternatively, the optimization condition setting unit 110 may receive the designation related to the surrounding grid points by the user.

In the example in FIG. 11, the surrounding grid points P1 to P8 used for determining the allowable range are adjacent grid points adjacent to any of the target grid points PA, PB, PC, and PD. However, the allowable range related to the ink amount of the target grid point may be determined using a grid point farther from the target grid point than the adjacent grid point as the surrounding grid point. An example of the allowable ranges related to the ink amounts of the two target grid points PA, PB will hereinafter be described.

The corrected ink amount CIA_PA at the first target grid point PA is restricted within the allowable range set around an average value of the ink amounts IA_P1, IA_P2, IA_PB, and IA_PC at the grid points P1, P2, PB, and PC adjacent to the target grid point PA. The allowable range is set to, for example, 100±α% when the average value Ave(IA_P1, IA_P2, IA_PB, IA_PC) of the ink amounts IA_P1, IA_P2, IA_PB, and IA_PC is assumed to be 100% and α is defined as a positive specified value less than 100. The specified value α is set to a value in a range of, for example, 10 to 30.

Note that in the color value space, there are six adjacent grid points adjacent to the first target grid point PA. The allowable range related to the corrected ink amount CIA_PA at the target grid point PA is preferably determined using all of these six adjacent grid points, but two adjacent grid points existing in the b-axis direction in the color value space are not illustrated in FIG. 11.

The corrected ink amount CIA_PB at the second target grid point PB is set to 100±α% when the average value Ave(CIA_PA, IA_P3, IA_P4, IA_PD) of the ink amounts CIA_PA, IA_P3, IA_P4, and IA_PD at the grid points PA, P3, P4, and PD adjacent to the target grid point PB is assumed to be 100%. The allowable range for the corrected ink amount CIA_PB at the target grid point PB is preferably determined using all of the six adjacent grid points adjacent to the target grid point PB. Note that since the optimization processing is performed on the target grid point PA before the optimization processing on the target grid point PB, the ink amount CIA_PA used for determining the allowable range of the corrected ink amount CIA_PB at the target grid point PB is the ink amount corrected by the optimization.

As can be understood from the example in FIG. 11, the allowable range related to the ink amount at the target grid point TP is determined from the ink amounts of the surrounding grid points existing around the target grid point TP. By executing the optimization processing related to the corrected ink amount CIA of the target grid point TP with the allowable range as the constraint condition, it is possible to prevent the ink amount at the adjacent grid point from rapidly fluctuating. That is, there is an advantage that the ink amount gradation can be smoothed.

The restriction of the corrected ink amount CIA related to the target grid point TP is applied for each ink type. For example, when a set of ink amounts is configured with six types of ink, the allowable range is set and applied for each of the six types of ink. Note that processing of limiting the corrected ink amount CIA so as to fall within the set allowable range can be referred to as “smoothing processing”.

As described above, in the second embodiment, the optimization processing is executed under the constraint condition that the corrected ink amount CIA of the target grid point TP falls within the allowable range determined from the ink amounts at the plurality of surrounding grid points existing around the target grid point TP. As a result, it is possible to prevent the corrected ink amount CIA at the target grid point TP from rapidly changing from the ink amounts at the surrounding grid points.

### C. Third Embodiment

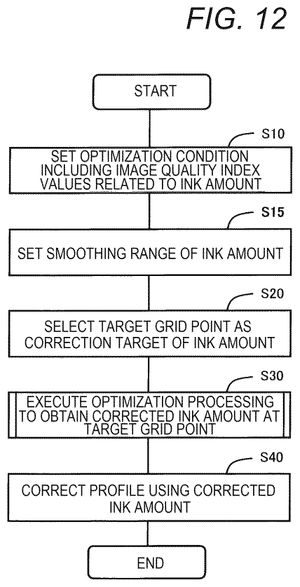

FIG. 12 is a flowchart illustrating a procedure of profile correction processing in a third embodiment. The third embodiment is the same in apparatus configuration as the first embodiment. The third embodiment is different from the first embodiment in the point that step S15 is inserted between step S10 and step S20 and in the detailed procedure of step S30, and is substantially the same as the first embodiment in other points.

In step S15, the optimization condition setting unit 110 sets a smoothing range of the ink amount. The smoothing range of the ink amount is a range in which the surrounding grid points to be corrected so that the ink amount does not rapidly change from the surroundings are determined out of the grid points existing around the target grid point TP.

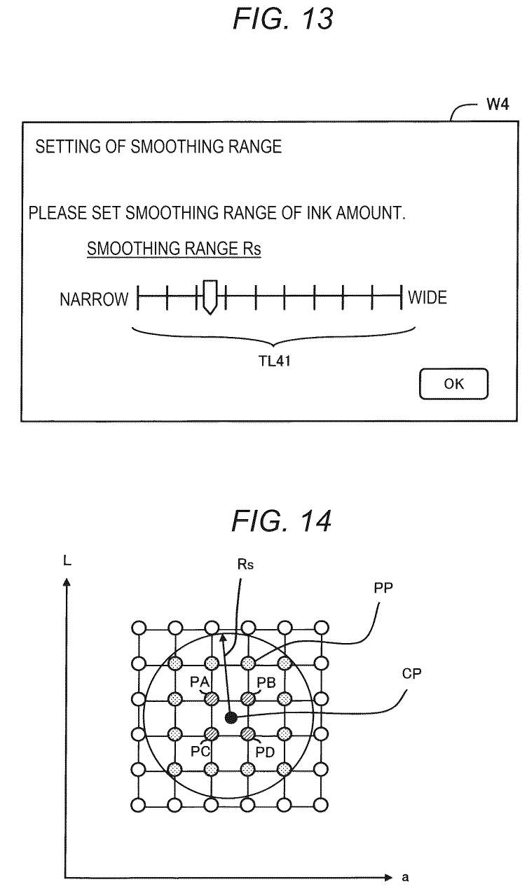

FIG. 13 is a diagram illustrating an example of a window used for setting the smoothing range of the ink amount. This window W4 includes a tool TL41 for the user to set the width of the smoothing range Rs. In the example in FIG. 13, the tool TL41 is a slide bar. Note that the smoothing range Rs may be determined in accordance with a rule set in advance without the user setting the smoothing range Rs.

FIG. 14 is a diagram illustrating an example of the smoothing range Rs of the ink amount. In this example, the surrounding grid points PP existing in a sphere having a radius Rs around the center point CP of the four target grid points PA, PB, PC, and PD are hatched with graining. With respect to these surrounding grid points PP, the ink amounts at the surrounding grid points PP are corrected so that the ink amounts fall within an allowable range determined from the ink amounts at the plurality of grid points adjacent to the surrounding grid points PP. Note that the smoothing range Rs is not limited to a sphere, and may be set with other three-dimensional shape such as a cube.

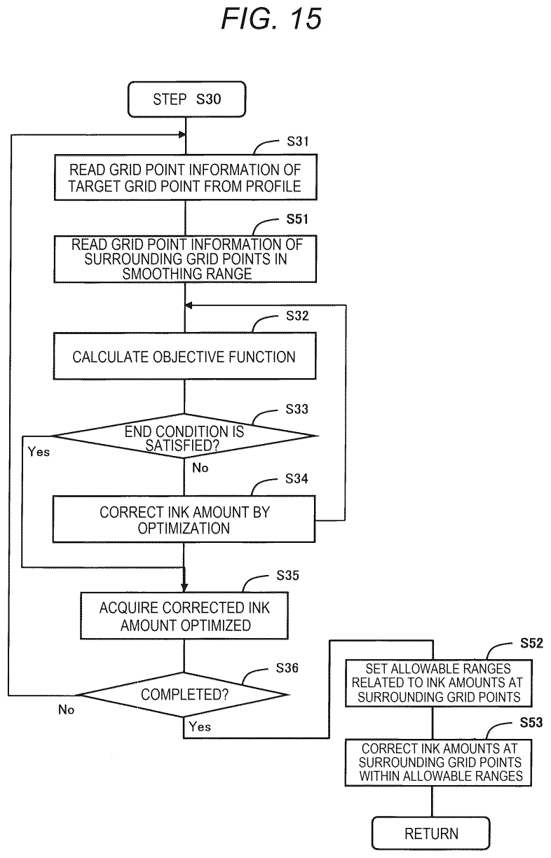

FIG. 15 is a flowchart showing a processing procedure of step S30 in the third embodiment. The detailed procedure of step S30 in the third embodiment is different from the first embodiment in the point that step S51 is inserted between step S31 and step S32, and in the point that steps S52, S53 are added after step S36, and is substantially the same as the first embodiment except in other points.

In step S51, the ink amount correction unit 140 reads the grid point information of the surrounding grid points existing in the smoothing range Rs from the profile PF. In step S52, the ink amount correction unit 140 sets allowable ranges related to the ink amounts at the surrounding grid points. In step S53, the ink amount correction unit 140 executes the smoothing processing for correcting the ink amounts of the surrounding grid points within the allowable ranges. It is preferable that the smoothing processing is executed after the optimization processing is completed for all the target grid points TP as the targets of the image quality improvement.

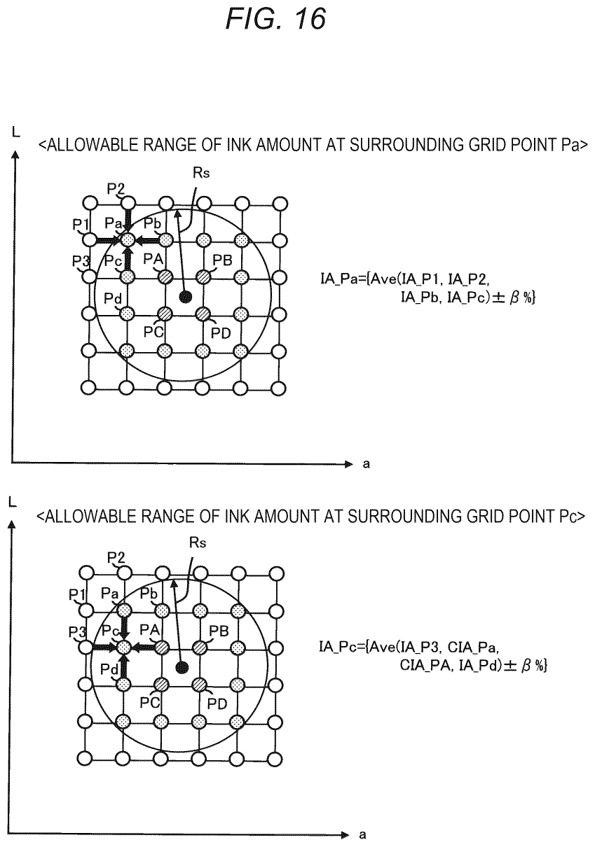

FIG. 16 is a diagram illustrating an example of allowable ranges related to the ink amounts at surrounding grid points located in the smoothing range. The grid points PA to PD are target grid points to be subjected to the image quality improvement, the grid points Pa to Pd are surrounding grid points located within the smoothing range, and the grid points P1 to P3 are grid points located outside the smoothing range. It is assumed that the correction of the ink amount by the optimization processing is completed for the target grid points PA to PD, and the smoothing processing of the ink amount is executed for the two surrounding grid points Pa, Pc in this order. The allowable range regarding the ink amount of each surrounding grid point is determined from the ink amounts at a plurality of grid points adjacent to the surrounding grid point.

The grid points used to determine the allowable range related to the ink amount IA_Pa of the first surrounding grid point Pa are all the grid points adjacent to the surrounding grid point Pa. The ink amount IA_Pa at the first surrounding grid point Pa is limited within an allowable range set around an average value of the ink amounts IA_P1, IA_P2, IA_Pb, and IA_Pc at the adjacent grid points P1, P2, Pb, and Pc. The allowable range is set to, for example, 100±β% when the average value Ave(IA_P1, IA_P2, IA_Pb, IA_Pc) of the ink amounts IA_P1, IA_P2, IA_Pb, and IA_Pc is assumed to be 100% and β is defined as a positive specified value less than 100. The specified value β is set to a value in a range of, for example, 10 to 30.

The grid points used to determine the allowable range related to the ink amount IA_Pc of the second surrounding grid point Pc are all the grid points adjacent to the surrounding grid point Pc. The allowable range of the ink amount IA_Pc at the second surrounding grid point Pc is set to 100±β% when the average value Ave(IA_P3, CIA_Pa, CIA_PA, IA_Pd) of the ink amounts IA_P3, CIA_Pa, CIA_PA, IA_Pd at the adjacent grid points P3, Pa, PA, Pd is assumed to be 100%. The ink amount CIA_Pa at the first surrounding grid point Pa used here is the ink amount after the smoothing processing related to the first surrounding grid point Pa. The ink amount CIA_PA at the target grid point PA is the corrected ink amount after the optimization processing.

As can be understood from the example in FIG. 16, the allowable range used in the smoothing processing related to the ink amount at the surrounding grid point is determined from the ink amounts at the plurality of grid points adjacent to the surrounding grid point. By correcting the ink amount at the surrounding grid point so as to fall within the allowable range, it is possible to prevent the ink amounts at the adjacent grid points from rapidly fluctuating. That is, there is an advantage that the ink amount gradation can be smoothed.

The smoothing processing related to the ink amount of the surrounding grid point described above is applied for each ink type. For example, when a set of ink amounts is configured with six types of ink, an allowable range is set and applied for each of the six types of ink.

In the smoothing processing of the surrounding grid points, it is preferable to determine the corrected ink amounts so that the color values reproduced by the corrected ink amounts do not substantively change from the original color values. That is, it is preferable that the corrected ink amounts are determined such that the color difference between the color values reproduced by the corrected ink amounts and the original color values stored at the surrounding grid points are equal to or less than the minute allowable color difference. Such smoothing processing can be executed in the following procedure.
(b1) Initial values of the ink amounts after the smoothing processing are obtained from the original color values stored at the surrounding grid points using inverse conversion of the color prediction model 144.
(b2) The ink amounts after the smoothing processing are obtained by executing the optimization processing so that the color values reproduced from the ink amounts after the smoothing processing substantively coincide with the original color values under the constraint condition that the ink amounts at the surrounding grid points fall within the allowable ranges using the initial values of the ink amounts. On this occasion, the color values reproduced from the ink amounts after the smoothing processing can be calculated using the color prediction model 144.

As described above, in the third embodiment, the ink amounts of the surrounding grid points existing around the target grid point TP are corrected so as to fall within the allowable ranges determined from the ink amounts at the plurality of grid points adjacent to the surrounding grid points. As a result, it is possible to prevent the ink amounts from rapidly fluctuating at the surrounding grid points existing around the target grid point TP.

Note that the smoothing processing related to the surrounding grid points in the third embodiment may be applied to the second embodiment. In this case, the specified value α used for setting the first allowable range related to the ink amount of the target grid point TP described in the second embodiment and the specified value β used for setting the second allowable range related to the ink amount of the surrounding grid point described in the third embodiment may be set to respective values different from each other. Alternatively, the specified values α, β may be set to the same value.

### Other Aspects

The present disclosure is not limited to the embodiments described above, and can be implemented in various forms without departing from the scope of the present disclosure. For example, the present disclosure may also be implemented in the following aspects. The technical features in the embodiments described above corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.

(1) According to a first aspect of the present disclosure, there is provided an information processing apparatus that corrects a profile for converting a color value into an ink amount. The information processing apparatus includes an optimization condition setting unit configured to set an optimization condition including an image quality index value related to the ink amount, a grid point selection unit configured to select a target grid point to be corrected out of a plurality of grid points contained in the profile, an ink amount correction unit configured to correct the ink amount at the target grid point into a corrected ink amount by executing optimization processing so as to improve the image quality index value, and a profile correction unit configured to correct the profile using the corrected ink amount.

According to this information processing apparatus, since the profile is corrected so as to improve the image quality index value, the image quality can be improved independently of the image.

(2) In the information processing apparatus described above, the optimization processing may include a constraint condition that the corrected ink amount at the target grid point falls within a first allowable range determined from ink amounts at a plurality of surrounding grid points existing around the target grid point.

According to this information processing apparatus, it is possible to prevent the corrected ink amount at the target grid point from rapidly changing from the ink amount at the surrounding grid point.

(3) In the information processing apparatus described above, the ink amount correction unit may correct the ink amount at the surrounding grid point so that the ink amount at the surrounding grid point existing around the target grid point falls within a second allowable range determined from ink amounts of a plurality of grid points adjacent to the surrounding grid point.

According to this information processing apparatus, it is possible to prevent the ink amount from rapidly fluctuating at the surrounding grid points existing around the target grid point.

(4) In the information processing apparatus described above, the optimization condition setting unit may be configured to receive a designation by a user related to a range of the surrounding grid point.

According to this information processing apparatus, it is possible to arbitrarily set the range of the surrounding grid points as the target of the ink amount correction.

(5) In the information processing apparatus described above, the optimization processing may be multi-objective optimization processing using a first objective function related to the image quality index value and a second objective function related to a color difference between the color value at the target grid point and a color value inversely converted from the corrected ink amount using the profile.

According to this information processing apparatus, the profile can be corrected such that the image quality index value is good and the color value corresponding to the corrected ink amount does not excessively fluctuate.

(6) In the information processing apparatus described above, the image quality index value may include one or more of a graininess index value, a color inconstancy index value, an ink coverage index value, an ink number index value, and an ink amount index value.

According to this information processing apparatus, the profile can be corrected so as to improve one or more image quality index values.

(7) In the information processing apparatus described above, the optimization condition may include a target value of the image quality index value, and the grid point selection unit may automatically select, as the target grid point, a grid point at which the image quality index value before correcting the ink amount does not reach the target value.

According to this information processing apparatus, it is possible to automatically select the target grid point which is the target of the ink amount correction without the user designating the target grid point.

(8) According to a second aspect of the present disclosure, there is provided a method of correcting a profile for converting a color value into an ink amount. The method includes (a) setting an optimization condition including an image quality index value related to the ink amount, (b) selecting a target grid point to be corrected out of a plurality of grid points contained in the profile, (c) correcting the ink amount at the target grid point into a corrected ink amount by executing optimization processing so as to improve the image quality index value, and (d) correcting the profile using the corrected ink amount.

(9) According to a third aspect of the present disclosure, there is provided a non-transitory computer-readable storage medium storing a computer program for correcting a profile for converting a color value into an ink amount. The computer program makes a computer execute processing including (a) setting an optimization condition including an image quality index value related to the ink amount, (b) selecting a target grid point to be corrected out of a plurality of grid points contained in the profile, (c) correcting the ink amount at the target grid point into a corrected ink amount by executing optimization processing so as to improve the image quality index value, and (d) correcting the profile using the corrected ink amount.

The present disclosure can also be implemented in various forms other than the information processing apparatus, the method, and the computer program. For example, the present disclosure can be implemented in the form of a method of processing an image or a non-transitory storage medium storing the computer program.

What is claimed is:

1. An information processing apparatus configured to correct a profile for converting a color value into an ink amount, the apparatus comprising:
an optimization condition setting unit configured to set an optimization condition including an image quality index value related to the ink amount;
a grid point selection unit configured to select a target grid point to be corrected out of a plurality of grid points contained in the profile;
an ink amount correction unit configured to correct the ink amount at the target grid point into a corrected ink amount by executing optimization processing so as to improve the image quality index value; and
a profile correction unit configured to correct the profile using the corrected ink amount.

2. The information processing apparatus according to claim 1, wherein
the optimization processing includes a constraint condition that the corrected ink amount at the target grid point falls within a first allowable range determined from ink amounts at a plurality of surrounding grid points existing around the target grid point.

3. The information processing apparatus according to claim 1, wherein
the ink amount correction unit corrects the ink amount at the surrounding grid point so that the ink amount at the surrounding grid point existing around the target grid point falls within a second allowable range determined from ink amounts of a plurality of grid points adjacent to the surrounding grid point.

4. The information processing apparatus according to claim 3, wherein
the optimization condition setting unit is configured to receive a designation by a user related to a range of the surrounding grid point.

5. The information processing apparatus according to claim 1, wherein
the optimization processing is multi-objective optimization processing using a first objective function related to the image quality index value and a second objective function related to a color difference between the color value at the target grid point and a color value inversely converted from the corrected ink amount using the profile.

6. The information processing apparatus according to claim 1, wherein
the image quality index value includes one or more of a graininess index value, a color inconstancy index value, an ink coverage index value, an ink number index value, and an ink amount index value.

7. The information processing apparatus according to claim 1, wherein
the optimization condition includes a target value of the image quality index value, and
the grid point selection unit automatically selects, as the target grid point, a grid point at which the image quality index value before correcting the ink amount does not reach the target value.

8. A method of correcting a profile for converting a color value into an ink amount, the method comprising:
(a) setting an optimization condition including an image quality index value related to the ink amount;
(b) selecting a target grid point to be corrected out of a plurality of grid points contained in the profile;
(c) correcting the ink amount at the target grid point into a corrected ink amount by executing optimization processing so as to improve the image quality index value; and
(d) correcting the profile using the corrected ink amount.

9. A non-transitory computer-readable storage medium storing a computer program configured to correct a profile for converting a color value into an ink amount, the program making a computer execute processing comprising:
(a) setting an optimization condition including an image quality index value related to the ink amount;
(b) selecting a target grid point to be corrected out of a plurality of grid points contained in the profile;
(c) correcting the ink amount at the target grid point into a corrected ink amount by executing optimization processing so as to improve the image quality index value; and
(d) correcting the profile using the corrected ink amount.
